(19) United States
(12) Patent Application Publication
(10) Pub. No.: US 2023/0185782 A1
(43) Pub. Date: Jun. 15, 2023

(54) DETECTION OF ANOMALOUS RECORDS WITHIN A DATASET

(71) Applicant: McKesson Corporation, Irving, TX (US)

(72) Inventors: Olufunso Kumolu, Trophy Club, TX (US); Hua Lin, Irving, TX (US); Lingyu Li, McKinney, TX (US)

(21) Appl. No.: 17/546,744

(22) Filed: Dec. 9, 2021

(51) Int. Cl. G06F 16/215; G06F 16/28; G06K 9/62

(52) U.S. Cl. CPC G06F 16/215; G06F 16/285; G06K 9/627

(57) ABSTRACT

Technologies are provided for detection of anomalous records in a dataset. In some embodiments, a computing system can access a dataset comprising multiple records and at least one configuration attribute, where a first configuration attribute of the at least one configuration attribute is indicative of a detection interval. The computing system also can generate, using a first subset of the multiple records, a detection model to determine presence or absence of an anomalous record within the multiple records. The computing system can select a second subset of the multiple records, wherein the second subset includes second records within the detection interval. The computing system can further generate classification attributes for respective ones of the second records by applying the detection model to the second subset, where a first classification attribute of the classification attributes designates a first one of the second records as either normal or anomalous.

### SUMMARY

It is to be understood that both the following general description and the following detailed description are illustrative and explanatory only and are not restrictive.

In one embodiment, the disclosure provides a computing system. The computing system includes at least one processor; and at least one memory device having processor-executable instructions stored thereon that, in response to execution by the at least one processor, cause the computing system to access a dataset comprising multiple records; and access at least one configuration attribute. A first configuration attribute of the at least one configuration attribute is indicative of a detection interval. The processor-executable instructions, in response to execution by the at least one processor, also cause the computing system to generate, using a first subset of the multiple records, a detection model to determine presence or absence of an anomalous record within the multiple records; select a second subset of the multiple records, the second subset comprising second records within the detection interval; and generate classification attributes for respective ones of the second records by applying the detection model to the second subset. A first classification attribute of the classification attributes designates a first one of the second records as one of normal or anomalous.

In another embodiment, the disclosure provides a computer-implemented method. The computer-implemented method includes accessing, by a computing system comprising at least one processor, a dataset comprising multiple records; and accessing, by the computing system, at least one configuration attribute. A first configuration attribute of the at least one configuration attribute is indicative of a detection interval. The computer-implemented method also includes generating, by the computing system, using a first subset of the multiple records, a detection model to determine presence or absence of an anomalous record within the multiple records; selecting, by the computing system, a second subset of the multiple records, the second subset comprising second records within the detection interval; and generating, by the computing system, classification attributes for respective ones of the second records by applying the detection model to the second subset. A first classification attribute of the classification attributes designates a first one of the second records as one of normal or anomalous.

In yet another embodiment, the disclosure provides a computer-program product. The computer-program product includes at least one computer-readable non-transitory storage medium having processor-executable instructions stored thereon that, in response to execution, cause a computing system to: access a dataset comprising multiple records; and access at least one configuration attribute. A first configuration attribute of the at least one configuration attribute is indicative of a detection interval. The processor-executable instructions, in response to execution, also cause the computing system to generate, using a first subset of the multiple records, a detection model to determine presence or absence of an anomalous record within the multiple records; select a second subset of the multiple records, the second subset comprising second records within the detection interval; and generate classification attributes for respective ones of the second records by applying the detection model to the second subset. A first classification attribute of the classification attributes designates a first one of the second records as one of normal or anomalous.

Additional elements or advantages of this disclosure will be set forth in part in the description which follows, and in part will be apparent from the description, or may be learned by practice of the subject disclosure. The advantages of the subject disclosure can be attained by means of the elements and combinations particularly pointed out in the appended claims.

This summary is not intended to identify critical or essential features of the disclosure, but merely to summarize certain features and variations thereof. Other details and features will be described in the sections that follow. Further, both the foregoing general description and the following detailed description are illustrative and explanatory only and are not restrictive of the embodiments of this disclosure.

### BRIEF DESCRIPTION OF THE DRAWINGS

The annexed drawings are an integral part of the disclosure and are incorporated into the subject specification. The drawings illustrate example embodiments of the disclosure and, in conjunction with the description and claims, serve to explain at least in part various principles, elements, or aspects of the disclosure. Embodiments of the disclosure are described more fully below with reference to the annexed drawings. However, various elements of the disclosure can be implemented in many different forms and should not be construed as limited to the implementations set forth herein. Like numbers refer to like elements throughout.

FIG. 1 illustrates an example of an operating environment for detection of anomalous records within a dataset, in accordance with one or more embodiments of this disclosure.

FIG. 2 is schematic block diagram of an example computing system for detection of anomalous records within a dataset, in accordance with one or more embodiments of this disclosure.

FIG. 3A illustrates an example of a user interface (UI) in accordance with one or more embodiments of this disclosure.

FIG. 3B illustrates an example of another UI in accordance with one or more embodiments of this disclosure.

FIG. 4 illustrates an example of yet another UI in accordance with one or more embodiments of this disclosure.

FIG. 5A illustrates an example of still another UI in accordance with one or more embodiments of this disclosure.

FIG. 5B illustrates an example of another UI in accordance with one or more embodiments of this disclosure.

FIG. 6A illustrates an example of yet another UI in accordance with one or more embodiments of this disclosure.

FIG. 6B illustrates an example of still another UI in accordance with one or more embodiments of this disclosure.

FIG. 7 illustrates an example of a method for detecting anomalous records within a dataset, in accordance with one or more embodiments of this disclosure.

FIG. 8 illustrates an example of a method for generating a detection model to determine presence or absence of anomalous records within a dataset, in accordance with one or more embodiments of this disclosure.

FIG. 9 illustrates an example of another operating environment that can implement detection of anomalous records within a dataset in accordance with one or more embodiments of this disclosure.

### DETAILED DESCRIPTION

The disclosure recognizes and addresses, among other technical challenges, the issue of anomaly detection in datasets. To that end, embodiments of this disclosure, individually or in combination, provide flexible, interactive configuration of a desired anomaly analysis, and also can provide execution of the configured anomaly analysis. Embodiments that execute such an analysis can determine present or absence of one or several records that deviate from a pattern obeyed by other records within a dataset. A record that deviates from such a pattern can be referred to as an anomalous records. The anomaly analysis described herein can be performed for a various types of data. Those types of data can include, for example, business analytics data, including pricing, sales, contract, inventory, or similar. Configuration and execution of the anomaly analysis can be separated into respective environments. Interactive configuration of the desired anomaly analysis can be afforded by a sequence of one or more multiple user interfaces presented at a client device. Such an interactive configuration can leverage attributes of a dataset (such as structure of a table) that is selected for anomaly analysis. In some cases, configuration of the anomaly analysis can be accomplished by means of application programming interfaces (APIs). In addition, or in other cases, implementation of a configured anomaly analysis also can be implemented via one or multiple APIs.

In sharp contrast to existing technologies, by separating configuration of the anomaly analysis from execution of that anomaly analysis, embodiments of the disclosure avoid building (e.g., linking and compiling) case-specific anomaly-detection computational tools. Instead, this disclosure provides a computing system that can be built one time and can then perform a wide variety of anomaly analyses by leveraging configurable attributes that define a desired anomaly analysis. Because the complexities of implementing and performing the desired anomaly analysis can be shifted away from a client domain into a server domain, embodiments of the disclosure can be readily accessible to client devices operated by analysts of disparate computational proficiency (ranging from users to developers, for example). In addition, the flexibility and the access to advanced analytical tools that are afforded by embodiments of this disclosure can improve quality and speed of decision-making by a business unit or other types of organizations.

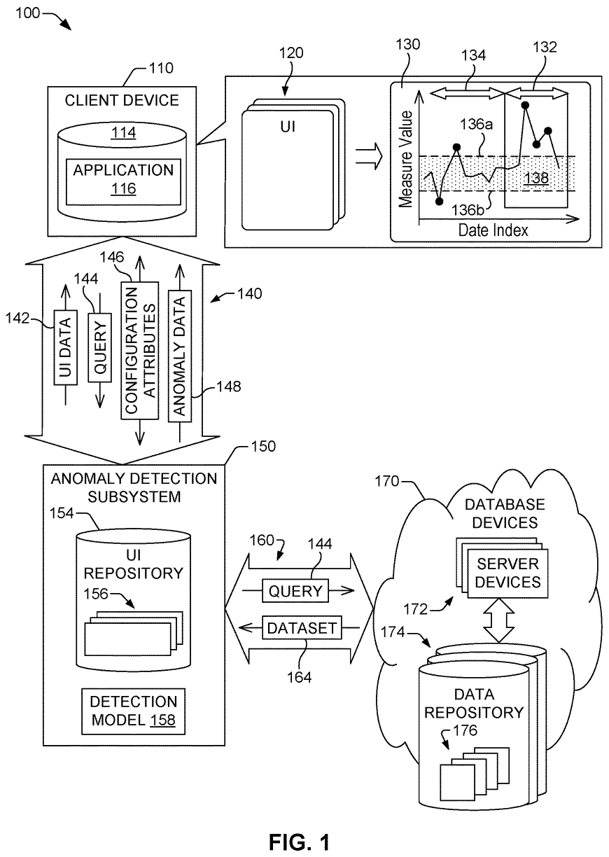

With reference to the drawings, FIG. 1 illustrates an example of an operating environment 100 for detection of anomalous records within a dataset, in accordance with one or more embodiments of this disclosure. The operating environment 100 includes a client device 110 that can execute a client application 116 to permit analysis of datasets. Execution of the client application 116 can permit, in some cases, detection of anomalous record(s) in one or several of the datasets. The client application 116 can be retained in one or several memory devices 114 (referred to as memory 114) and can be embodied in a web browser, a mobile application, or similar software application. The client device 110 can be embodied in, for example, a personal computer, a laptop computer, an electronic-reader (e-reader) device, a tablet computer, a smartphone, a smartwatch or similar device.

Execution of the client application 116 can cause the client device 110 to present a sequence of user interfaces 120 to configure the analysis of a dataset and to review results of the analysis. A display device (not depicted in FIG. 1) that can be integrated into the client device 110, or is functionally coupled thereto, can present the sequence of user interfaces 120. More specifically, as a result of execution of the client application 116, the client device 110 can present a first UI in the sequence of user interfaces 120. The first UI can serve as a home page or a landing page for the client application 116. In one example, the first UI can include indicia conveying instructions of how to configure and/or use anomaly detection as implemented by an anomaly detection subsystem 150 that is included in the operating environment 100.

To present the first UI, in response to executing the client application 116, the client device 110 can receive first UI data 142 from the anomaly detection subsystem 150. The first UI data 142 can include formatting data defining formatting attributes of UI elements to be presented within the first UI. The formatting data also can define a layout of those UI elements. In this disclosure, a formatting attribute can be embodied in, or can include, a code that defines a characteristic of a UI element presented on a user interface. The code can define, for example, a font type; a font size; a color; a length of a line; thickness of a line, a size of a viewport or bounding box; presence or absence of an overlay; type and size of the overlay, or similar characteristics. The code can be a numerical value or an alphanumerical value, in some cases.

As is illustrated in FIG. 1, the anomaly detection subsystem 150 can be remotely located relative to the client device 110, and can send the first UI data 142 by means of a communication network 140. The network architecture 140 can include one or a combination of networks (wireless or wireline) that permit one-way and/or two-way communication of data and/or signaling. The anomaly detection subsystem 150 can include one or more memory devices 154 (referred to as UI repository 154) that includes UI data 156 defining multiple user interfaces. Each one of the multiple interfaces represented with an unmarked rectangle in FIG. 1. The first UI data 142 can be retained in the UI repository 154, within the UI data 156.

In some embodiments, the first UI can include a selectable visual element that, in response to being selected, can cause the client device 110 to present a second UI as part of the sequence of user interfaces 120. To that, the client device 110 can execute, or can continue executing, the client application 116 to receive second UI data 142 from the anomaly detection subsystem 150. The second UI data 142 also can be retained in the UI repository 154, within the UI data 156. The second UI data 142 can include formatting data defining formatting attributes of UI elements to be presented within the second UI. The formatting data also can define a layout of those UI elements.

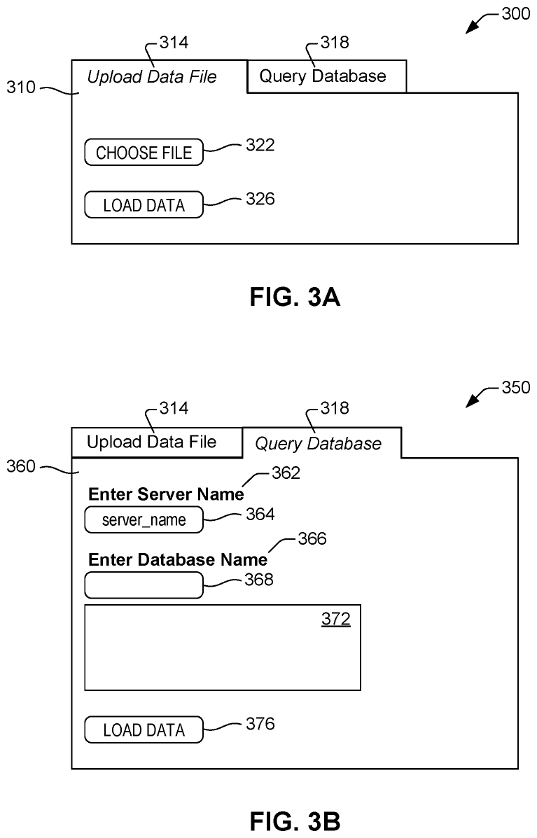

The second UI can include, in some embodiments, multiple selectable visual elements that can permit supplying a dataset for analysis to the anomaly detection subsystem 150. The dataset comprises multiple records. A first selectable visual element of the multiple selectable visual elements, in response to being selected, can permit the client device 110 to obtain a document from the memory 114. The document contains the dataset, and in some cases, the document can be a comma-separated file. The client device 110 can send the document to the anomaly detection subsystem 150. In some cases, the document can be sent in response to selection of a second selectable visual element of the multiple selectable visual elements. The UI 300 shown in FIG. 3A is an example of the second UI. The UI 300 includes a pane 310 having a selectable UI element 322. In response to being selected, the selectable UI element 322 can cause the client device 110 to present one or more other user interfaces to navigate to and select a file within a file system of the client device 110. The selected file contains a desired dataset. The selectable UI element 322 is labeled “Choose File” simply for the sake of nomenclature. The pane 310 also has a selectable UI element 326 that, in response to being selected, causes the client device 110 to send the selected file to the anomaly detection subsystem 150.

In response to being selected, a second selectable visual element of the multiple selectable visual elements within the second UI (e.g., UI 300 shown in FIG. 3A) can cause the client device 110 to present a third UI in the sequence of user interfaces 120. The third UI also can include, in some embodiments, multiple selectable visual elements that can permit sending a query 144 to the anomaly detection subsystem 150. To that end, in some embodiments, the third UI can include a fillable pane that can permit an end-user to provide input information defining the query 144. In some cases, the query can be a SELECT query against a table retained in one or more databases. After the client device 110 has received that input information—and thus, the query 144 has been defined—the client device 110 can send the query 144 to the anomaly detection subsystem 150. In some cases, the query 144 can be sent in response to selection of another selectable visual element included in the third UI.

In addition, or in some embodiments, one or more selectable visual elements of the multiple selectable visual elements included in the third UI can permit defining a data domain where the query 144 is to be resolved. For instance, a first one of the one or more selectable visual elements can permit identifying a particular server device that administers contents of one or multiple databases. In addition, a second one of the one or more selectable visual elements can permit identifying a particular database of the database(s). The client device 110 can send first data and second data identifying the particular server device and the particular database, respectively, to the anomaly detection subsystem 150. In some cases, the first data and/or the second data can be incorporated into the query 144 as metadata. In other cases, the first data and/or the second data can be sent to in one or more transmission(s) separate from the query 144. For instance, the first data and/or the second data can be sent as part of configuration attributes 146.

As an illustration, the UI 350 shown in FIG. 3B is an example of the third UI. The client device 110 can present the UI 350 in response to selectable visual element 318 being selected. The UI 350 includes a pane 360 that has a selectable UI element 364 that, in response to being selected, permits identifying a desired server device. Indicia 362 within the pane 360 can convey a prompt to identify the particular server. The pane 360 also has a selectable UI element 368 that, in response to being selected, permits identifying a particular database. Indicia 366 within the pane 360 can convey a prompt to identify the particular database. The indicia 362 and indicia 366 are merely illustrative and other indicia also can be utilized. The pane 360 also has a fillable pane 372 that can receive input information defining the query 144. Further, the pane 360 also has a selectable UI element 376 that, in response to being selected, causes the client device 110 to send the defined query 144, first data defining the particular server device, and/or second data defining the particular database to the anomaly detection subsystem 150.

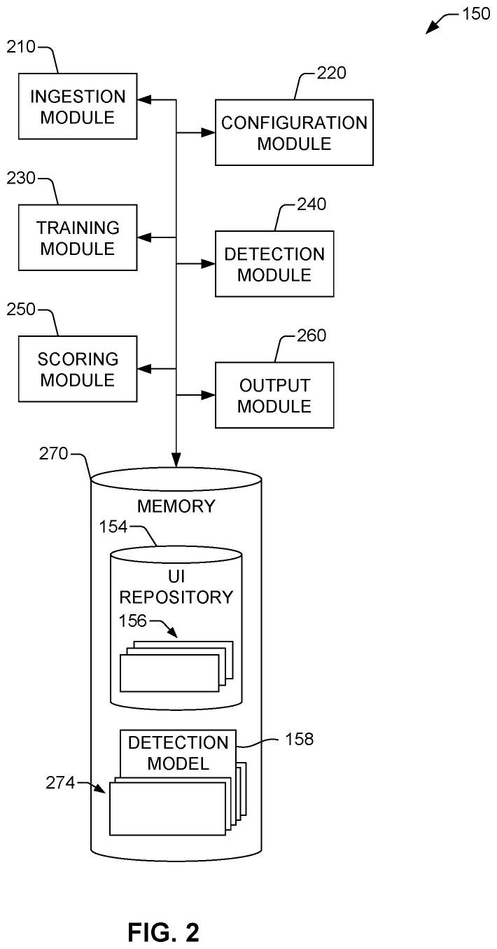

With further reference to FIG. 1, in scenarios where the query 144 is used to select a dataset for anomaly analysis, the anomaly detection subsystem 150 can receive the query 144 by means of the communication network 140. The anomaly detection subsystem 150 can resolve the query 144 and, as a result, can receive a dataset 164 for anomaly analysis. The dataset 164 includes multiple records that satisfy the query 144. The anomaly detection subsystem 150 can rely on database devices 170 to resolve the query 144. The anomaly detection subsystem 150 can receive the dataset 164 from one of the database devices 170. The database devices 170 can include, in some embodiments, multiple server devices 172 and multiple data repositories 174. A particular combination of the multiple server devices 172 and the multiple data repositories 174 constitutes a database. At least one of the multiple data repositories 174 can include multiple tables 176. Accordingly, such a database can include one or several of the multiple tables 176. Thus, in some embodiments, the multiple records in the dataset 164 can include first records that embody respective dimension records pertaining to a table of the tables 176. Additionally, the multiple records in the dataset 164 also include second records that embody respective measure records pertaining to that table. Moreover, the multiple records in the dataset 164 can further include third records that embody time records pertaining to the table. Each one of the first records identifies a respective value of a dimension in the table; each one of the second records identifies a respective value of a metric defining a measure in the table; and each one of the third records identifies a timestamp for a respective record in the table. In some embodiments, as is illustrated in FIG. 2, the anomaly detection subsystem 150 can include an ingestion module 210 that can receive the query 144. Additionally, the anomaly detection subsystem 150 also can include a configuration module 220 that can resolve the query 144.

As mentioned, in some cases, in addition to receiving the query 144, the anomaly detection subsystem 150 can receive data identifying a particular server device of the server devices 172. That particular server device can be functionally coupled to one or more of the data repositories 174. By sending the query 144 to that particular server device, the anomaly detection subsystem 150 can confine the resolution of the query 144 to a desired domain of records pertaining to a particular database. Consequently, not only can computing resources be used more efficiently in the resolution of the query 144, but records included in the dataset 164 can pertain to one or several particular databases of a desired type. For example, a particular database can include information related to mail-order pharmacies in specific geographic locations and quantity of medications fulfilled. As another example the particular database can include information identifying inventory quantity, sales quantity, a medication quantity, supply quantity, and/or quantify of prescriptions or medications that have been shipped.

Prior to anomaly analysis of the dataset 164, the anomaly detection subsystem 150 can send structure data identifying dimensions, measures, and date of the table corresponding to the dataset 164. Such structure data constitutes particular configuration attributes of the anomaly analysis. Thus, the anomaly detection subsystem 150 can send the structure data as part of the configuration attributes 146. A first one of the particular configuration attributes can identify a first dimension; a second one of the particular configuration attributes can identify a first measure; and a third one of the particular configuration attributes can identify a date column. Additionally, still prior to the anomaly analysis, the anomaly detection subsystem 150 can send particular UI data 142 defining formatting attributes. The particular UI data 142 also can be retained in the UI repository 154, within the UI data 156. The particular UI data 142 can include formatting data defining formatting attributes of UI elements to be presented within one or multiple interactive UIs. The formatting data also can define a layout of those UI elements. In some embodiments, the anomaly detection subsystem 150 can include an output module 260 that send the structure data and various types of UI data 142.

By sending such structure data and the particular UI data 142 to the client device 110, the anomaly detection subsystem 150 can cause the client device 110 to present one or multiple interactive user interfaces for configuration of characteristics of the anomaly analysis. Hence, in contrast to existing analysis technologies, the anomaly analysis can be interactively customized without changes to the anomaly detection subsystem 150. Accordingly, end-users can create a custom anomaly analysis to be performed by the anomaly detection subsystem 150, without coding or modeling experience.

More specifically, the client device 110 can execute, or can continue executing, the client application 116 to receive both the structure data contained in the configuration attributes 146 and the particular UI data 142 from the anomaly detection subsystem 150. In response to receiving such data, the client device 110 can present a fourth UI in the sequence of user interfaces 120. The fourth UI permits interactively configuring particular attributes of a desired anomaly analysis. To that end, the fourth UI can include multiple selectable visual elements.

A first subset of the multiple selectable visual elements can permit receiving input information defining the data scope of the desired anomaly analysis. That is, the input information can select a measure, a dimension, and a date column within the dataset 164. The measure, dimension, and date column can be selected based on the structure data that has been received from the anomaly detection subsystem 150. The measure defines a target variable (e.g., quantity of a particular product or item) to be analyzed for presence of anomalous records, and the dimension defines at least one independent variable determining values of the target variable. The measure, the dimension, and the date column define respective ones of the particular attributes of the desired anomaly analysis.

In addition, a first one of the multiple selectable visual elements can permit receiving input information defining a first parameter associated with a detection interval for the desired anomaly analysis. The first parameter defines one of the particular attributes of the desired anomaly analysis. The detection interval defines a time period where the anomaly detection subsystem 150 can determine presence of one or multiple anomalous records within the measure identified as a target variable. The time period has a lower bound defined by is a first time and an upper bound defined by a second time after the first time. In some cases, the first parameter defines a span of the detection interval; that is, the difference between the upper bound and the lower bound of the time period. Hence, the first parameters can be expressed in units of time (e.g., day or week). As an illustration, the first parameter can be three weeks, four weeks, or six weeks.

Further, in some embodiments, a second one of the multiple selectable visual elements can permit receiving input information defining a second parameter that can control sensitivity of detection of an anomalous record. Such a sensitivity represents a broadening of a sharp decision boundary corresponding to a detection model of this disclosure. The broadening can be controlled by that second parameter (which can be referred to as sensitivity parameter). The sensitivity parameter can be defined as an ordinal categorical parameter indicating, for example, one of multiple categories (or types) of sensitivity of detection.

In one example, there can be three categories of sensitivity—e.g., “low, “medium,” and “high.” Hence, the sensitivity parameter can indicate one of “low” sensitivity, “medium” sensitivity, and “high” sensitivity. In some embodiments, the three sensitivity categories can be converted to the standard error (or confidence interval) of a selected type of detection model. That standard error can then be applied as constraint during generation of the decision boundary of the selected detection model. In such an example, a sensitivity parameter value of “low” indicates using 85% confidence interval to determine the decision boundary and differentiate a normal record (falls within the decision boundary) from an anomalous record (falls outside of the decision boundary). Further, sensitivity parameter values of “medium” and “high” indicate using 80% and 70% confidence interval, respectively, to determine the decision boundaries. Embodiments of this disclosure are, of course, not limited to those particular confidence intervals.

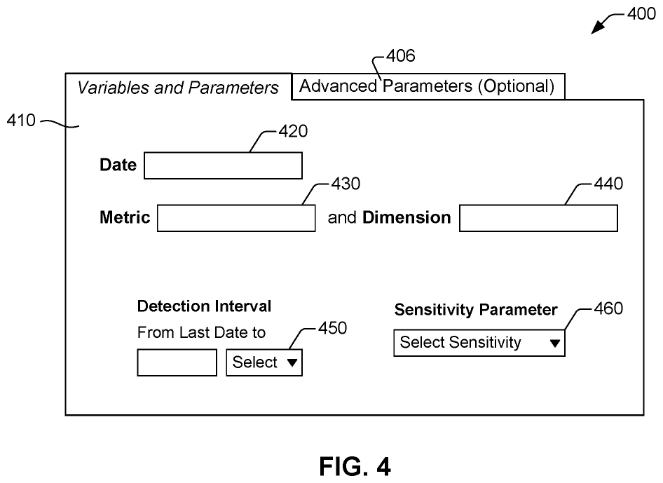

As an illustration, the UI 400 shown in FIG. 4 is an example of the fourth UI that permits interactively configuring particular attributes of a desired anomaly analysis. The client device 110 can present the UI 400 in response to receiving structure data corresponding the dataset 164 and UI data 142. The UI 400 includes a pane 410 that has a selectable UI element 420 that, in response to being selected, permits identifying a desired date column present in the dataset 164. The pane 400 also has a selectable UI element 430 that, in response to being selected, permits identifying the measure (or target variable) to be analyzed for presence of anomalous records. Further, the pane 410 also has a selectable UI element 440 that, in response to being selected, permits identifying a dimension that serves as an independent variable that determines magnitude of the measure.

The UI 400 also includes a selectable UI element 450 and a selectable UI element 460. Selection of the selectable UI element 450 permits defining a span of a detection interval. The span can be defined as an offset relative to a most recent date present in the date column identified via the selectable UI element 420. Selection of the selectable UI element 450 can present a menu of preset parameters (not depicted in FIG. 4), each defining a particular span (e.g., 3 weeks, four weeks, or six weeks). Selection of the selectable UI element 460 permits identifying a parameter that defines sensitivity of detection of anomalous records. The number of UI elements included in the UI 400 and the layout of those elements are merely illustrative and other UI elements and/or layouts can be contemplated.

After input information has been received using a configuration user interface, the client device 110 can execute, or can continue executing the client application 116, to send the particular attribute(s) that configure characteristics of the desired anomaly analysis to the anomaly detection subsystem 150. The client device 110 can send the particular attributes as part of the configuration attributes 146, via the communication network 140.

The anomaly detection subsystem 150 can receive the particular attributes within the configuration attributes 146, from the client device 110. The anomaly detection subsystem 150 can configure the detection interval based on the first parameter within the received configuration attributes 146. As mentioned, the first parameter can define the span of the time interval (e.g., three weeks) corresponding to the detection interval. The anomaly detection subsystem 150 can then configure the upper bound of the detection interval as the value of the most recent date within the date column identified in the configuration attributes 146. In addition, the anomaly detection subsystem 150 can configure the lower bound of the detection interval as the value of the date index (a date or another type of time, for example) in the date column that yields the defined span of the detection interval. In other words, the date index that corresponds to the time interval measured from the most-recent date. In some embodiments, the configuration module 220 (FIG. 2) can configure the detection interval.

In addition, the anomaly detection subsystem 150 can determine a training interval using the detection interval and the date column identified in the configuration attributes 146. The training interval precedes the detection interval. That is, the training interval contains historical dimension records relative to dimension records contained in the detection interval. More specifically, the training interval defines a second time period where the anomaly detection subsystem 150 can generate an anomaly detection model to determine presence or absence of anomalous records within a dataset (e.g., values of a target variable). The second time period has a lower bound defined by is a first time and an upper bound defined by a second time after the first time. The anomaly detection subsystem 150 can configure the lower bound of the second time period as the value of a date index identifying the earliest time in the date column within the dataset 164. In addition, the anomaly detection subsystem 150 can configure the upper bound of the second time period as the value of another date index that precedes the date index defining the lower bound of the detection interval. In some cases, the date index corresponding to the upper bound of the second time period can be immediately consecutive to the date index defining the lower bound of the detection interval. In some embodiments, the configuration module 220 (FIG. 2) can determine or otherwise configure the training interval.

Regardless of how the training interval is configured, the anomaly detection subsystem 150 can generate a detection model 158 based on the dataset 164 and the training interval. To that end, the anomaly detection subsystem 150 can select a subset of the multiple records included in the dataset 164. The subset includes first records within the training interval. The first records can include first measure records and first dimension records. As mentioned, the first measure records serve as values of a target variable (e.g., the metric corresponding to the measure records), and the first dimension records serve as values of an independent variable (e.g., time, geographical region, employee identification (ID), item ID, or similar). In addition, the anomaly detection subsystem 150 can train, using such a subset, the detection model 158 to classify a record as being one of a normal record or an anomalous record. The detection model 158 can be embodied in, or can include a time-series model, a median absolute deviation model, or an isolation forest model, for example. The detection model 158 can be trained using one or several unsupervised training techniques. In some embodiments, the anomaly detection subsystem 150 can include a training module 230 that can train the detection model 158.

Training the detection model 158 includes generating a first decision boundary and a second decision boundary. The first and second decision boundaries define a domain where values of respective measure records are deemed normal. Outside that domain, a value of a measure record is deemed anomalous. In other words, each one of the first and second decision boundary separates that domain from another domain where values of records are deemed anomalous. More specifically, the first decision boundary and the second decision boundary can define, respectively, an upper bound and a lower bound that can be compared to values of measure records. The trained detection model 158 classifies a measure record having a value within the interval defined by the upper bound and the lower bound as a normal record. The trained detection model 158 classifies another measure record having a value outside that interval as an anomalous record.

Embodiments of the disclosure also provide flexibility with respect to configuration of the detection model 158 that is trained for anomaly detection. In other words, anomaly analyses performed by the anomaly detection subsystem 150 need not be limited to a specific type of detection model 158. In some embodiments, the client device 110 can present a configuration user interface as part of the sequence of user interfaces 120, where the configurations user interface permits selecting the type of detection model 158 to be trained for anomaly analysis. The anomaly detection subsystem 150 can cause the client device 110 to present such a configuration user interface. As is illustrated in FIG. 2, the anomaly detection subsystem 150 can include a library of detection models 274 containing models of different types that can be applied to detect one or multiple anomalous records in a dataset. One of the detection models 274 can be configured a default model for anomaly analysis in cases where a particular detection model is not selected using a configuration interface. The library of detection models 274 are retained in one or more memory devices 270 (referred to as a memory 270). As also is shown in FIG. 2, the various modules can be functionally coupled to one another and to the memory 270 via a bus architecture (represented by arrows) or another type of communication architecture.

In addition, or in some embodiments, a training interval can be configured independently from a detection interval. Thus, a training interval need not be limited to being immediately consecutive to the detection interval. In some cases, the configuration user interface that permits selecting the type of detection model 158 also can permit defining both the training interval and the detection interval.

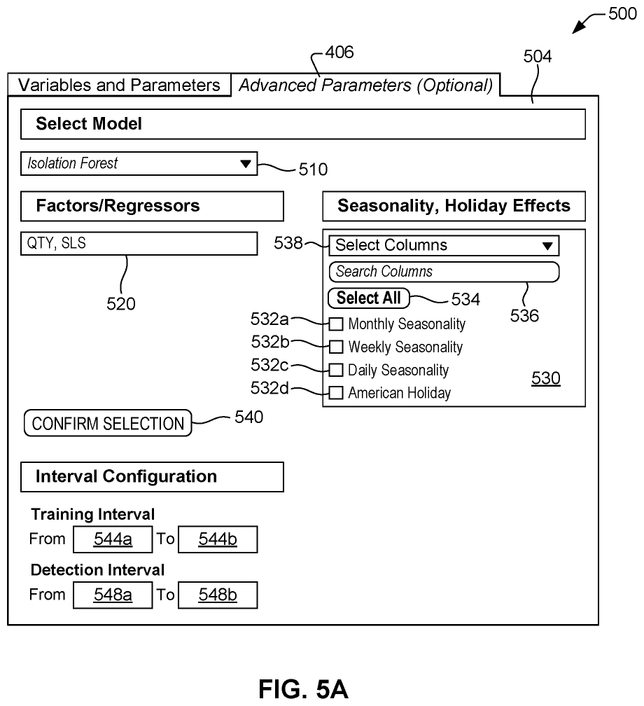

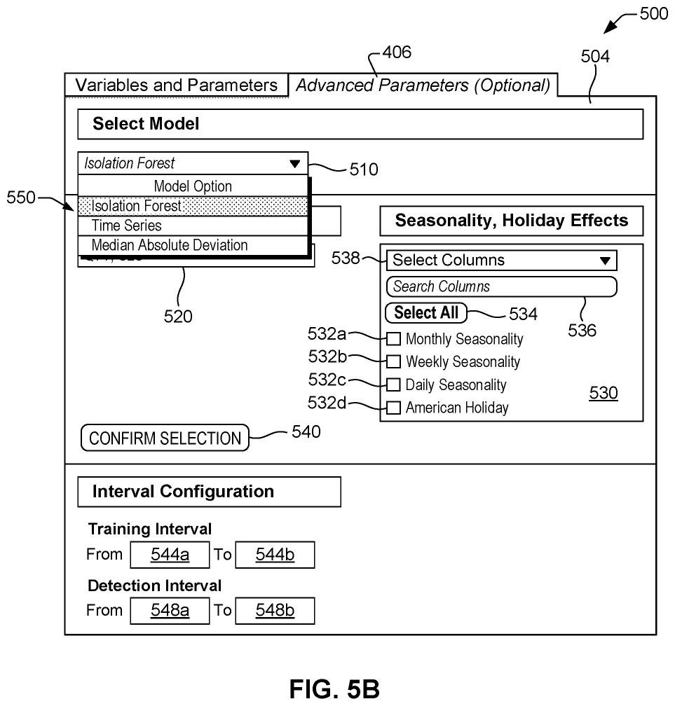

As an illustration, the UI 500 shown in FIG. 5A is an example of a configuration user interface that permits selection of the detection model 158, a training interval, and a detection interval. The UI 500 can be presented in response to selecting the selectable UI element 406 in the UI 400 (FIG. 4) in some cases. The UI 500 includes a pane 504 having multiple selectable UI elements that permit configuring the detection model 158. Specifically, the multiple selectable UI elements include a selectable UI element 510. Selection of the selectable UI element 510 permits identifying a type of statistical model that defines the detection model 158. As is shown in FIG. 5A, the selectable UI element can include text (“Isolation Forest”) corresponding to a prior-identified statistical model (e.g., a preset type of detection model 158 present in a library of models). As is illustrated in FIG. 5B, selection of the selectable UI element 510 can cause the client device 110 to present a menu 550 of models (e.g., statistical model(s) and/or machine learning model(s)). Each item in the menu 550 is selectable and includes text, or other markings, identifying a type of model. Selection of an item of the menu 550 can cause the client device 110 to redraw the menu 550 with the item highlighted or otherwise marked (represented by a stippled block in FIG. 5B).

The UI 500 also can include a fillable pane 520 that can receive input information defining one or multiple regressors that can serve as independent variables affecting the target variable defined by the measure selected for anomaly analysis. Examples of regressors include item quantity, item sales, and the like.

The UI 500 can further include a pane 530 having several selectable UI elements that permit incorporating various temporal effects into the relationship between the target variable and independent variable(s). As is illustrated, the temporal effects can include monthly seasonality, weekly seasonality, daily seasonality, and American holiday (international holidays also can be contemplated). Monthly seasonality can be selected via a selectable UI element 532a; weekly seasonality can be selected via a selectable UI element 532b; daily seasonality can be selected via a selectable UI element 532c; and America holiday can be selected via a selectable UI element 532d. Each one of those selectable UI elements is embodied in a checkbox, just for the sake of illustration. Selection of a selectable visual element 534 results in selection of all available seasonality and American holiday. Particular table columns can be searched using a selectable UI element 536 and, based on results of the search, a table column can be added as temporal effect. Further, selection of a selectable element 538 can cause presentation of a menu of table columns available for selection as a temporal effect.

Regardless of its type and how a temporal effect is selected, selection of one or more temporal effects results in respective regressors or model parameters being added to a time-series model used for detection of anomalous records. Accordingly, variation caused by seasonality and/or holiday factor can be incorporated in the generation of a decision boundary for a type of detection model that has been selected as described herein.

The UI 500 also includes a selectable UI element 540 that, in response to being selected, causes the client device 110 to send model information identifying the selection of the type of model, regressor(s), and/or seasonality effect(s). The model information can be sent to the anomaly detection subsystem 150, as part of the configuration attributes 146.

Besides permitting selection of the detection model 158 to be trained for anomaly analysis, the UI 500 can permit defining a lower bound and an upper bound of a training interval, and a lower bound and an upper bound of a detection interval. To that end, the UI 500 includes a first selectable UI element 544a and a second selectable UI element 544b that can receive, respectively, first input information and second input information. The first input information defines the lower bound of the training interval, and the second input information defines the upper bound of the training interval. Further, the UI 500 includes a third selectable UI element 548a and a fourth selectable UI element 548b that can receive, respectively, third input information and fourth input information. The third input information defines the lower bound of the detection interval, and the fourth information defines the upper bound of the detection interval.

The detection model 158 that has been trained can classify each one of the multiple records within the dataset 164 as either a normal record or an anomalous record. Thus, in some cases, after being trained, the detection model 158 can classify each one of the records within the detection interval. Classification of records in such a fashion constitutes a detection mechanism that can determine presence or absence of anomalous records in a dataset, within the detection interval.

Because the detection model 158 can be trained using an unsupervised training technique after a desired dataset has been obtained from a data repository, the anomaly detection subsystem 150 serves as a data-agnostic anomaly detection tool. Therefore, the anomaly detection subsystem 150 can be reconfigured in response to a dataset becoming available, in sharp contrast to existing technologies that are built (e.g., linked and compiled) for particular types of datasets.

The anomaly detection subsystem 150 can generate classification attributes for respective records of the dataset 164 within the detection interval by applying the trained detection model 158 to the respective records. In some cases, each one of the classification attributes designates a record as one of a normal record or an anomalous record. In other cases, each one of the classification attributes designates a record as one of a normal record, an anomalous record of a first type (e.g., “downtrend”), or an anomalous record of a second type (e.g., “spike”). Spike and downtrend denominations are simply illustrative and are provided simply for the sake of nomenclature. A first classification attribute of the classification attributes designates a first one of the respective records as either a normal record or an anomalous record; and a second classification attribute of the classification attributes designates a second one of the respective records as either a normal record or an anomalous record. In some embodiments, the anomaly detection subsystem can include a detection module 240 (FIG. 2) that can generate such classification attributes.

A classification attribute can be embodied in, or can include, a label. For purposes of illustration, the label can contain a string of characters that convey that a record is either a normal record or an anomalous record. In one example, the label can be one of “Normal” or “Anomalous.” In another example, the label can be one of “0”, “1,” or “−1,” where “0” designates a normal record, “1” designates an anomalous record of a first type; and “−1” designates an anomalous record of a second type.

In some embodiments, the anomaly detection subsystem 150 can determine anomaly scores for respective anomalous records that may have been identified within the dataset 164. Each one of the anomaly scores represents the magnitude of an anomaly. Specifically, a score σ for an anomalous record can be equal to the smallest distance between a metric value of the anomalous record and the first classification boundary or the second classification boundary. In some embodiments, the anomaly detection subsystem can include a scoring module 250 (FIG. 2) that can determine anomaly scores.

The anomaly detection subsystem 150 can generate anomaly data 148 defining an anomaly table. The anomaly table can include dimension records of the dataset 164 and dimensions records identifying respective classification attributes for corresponding ones of the dimension records. The dimension records pertain to the detection interval and correspond to the independent variable identified by the configuration attributes 146. In addition, or in other embodiments, the anomaly detection subsystem 150 also can embed anomaly scores into the anomaly table. The anomaly scores constitute second measure records. Each one of the anomaly scores that are added to the anomaly table corresponds to a respective dimension record identifying a record designated as an anomalous record. In some embodiments, the anomaly detection subsystem 150 can format the anomaly data 148 as a comma-separated document that includes multiple rows, each row including a dimension record, a measure record, and a classification attribute. In some cases, at least one of the multiple rows includes an anomaly score. In some embodiments, the anomaly detection subsystem 150 can include an output module 260 (FIG. 2) that can generate and supply the anomaly data 148.

In addition, or in some embodiments, the anomaly detection subsystem 150 can embed other data into the anomaly data 148. For example, the anomaly detection subsystem 150 can embed first data and second data identifying, respectively, the training interval and the detection interval corresponding to the dataset 164. Further, or as another example, the anomaly detection subsystem 150 can embed data summarizing the anomaly analysis into the anomaly data 148. Such data can include first data identifying a number of anomalous records and/or second data identifying a percentage of anomalous records. The output module 260 (FIG. 2) can embed such data into the anomaly data 148, in some embodiments.

The anomaly detection subsystem 150 can send the anomaly data 148 to the client device 110 by means of the communication network 140. The anomaly detection subsystem 150 also can send other UI data 142 including formatting data defining formatting attributes that control presentation of a results UI in the sequence of user interfaces 120. The results UI can summarize various aspects of anomaly analysis. Thus, the results UI can include multiple UI elements identifying at least a subset of the anomaly data 148.

The results UI can include a selectable visual element that, in response to being selected, permits identifying a data view to be plotted as a time series of the independent variable identified by the configuration attributes 146 and used in the anomaly analysis. In one example, to identify the data view, selection of the selectable visual element causes presentation of a menu of selectable item IDs having at least one anomalous record. Selection of the particular item ID can cause the client device 110 to present a user interface 130 that includes a graph of the data view identified by the particular item ID. The graph can be a two-dimensional plot of measure value as a function of time, where the ordinate corresponds to measure value and the abscissa corresponds to date index. The time domain shown in the abscissa includes a training interval 134 used to generate the detection model 158, and a detection interval 132 defining a detection window. The graph also presents a first decision boundary 136a and a second decision boundary 136b defining a domain where data records can be deemed to be normal. The domain is represented by a stippled rectangle in the user interface 130.

Anomalous records in the graph are represented by solid circles. An anomalous record that has a measure value below the second decision boundary 136b can be referred to as a “downtrend” record. An anomalous record having a measure value above the first decision boundary 136a can be referred to as a “spike” record. As mentioned, spike and downtrend denominations are simply illustrative and are provided simply for the sake of nomenclature.

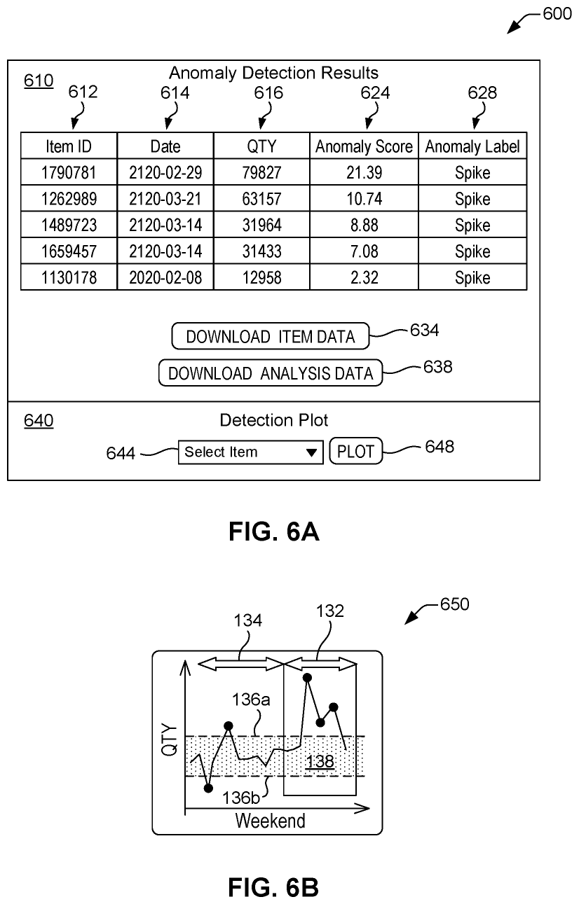

The UI 600 shown in FIG. 6A is an example of a results UI that presents an anomaly table that can be defined by first data within the anomaly data 148. In some cases, the client device 110 can present the UI 600 in response to receiving such first data, during execution of the client application 116. The anomaly table includes first dimension records corresponding to item ID, second dimension records corresponding to date, and measure records corresponding to quantity (QTY) of an item. The anomaly table also includes third dimension records corresponding to anomaly score and fourth dimension records corresponding to anomaly label. The UI 600 includes a pane 610 that has UI elements defining respective records. Specifically, the UI elements include UI elements 612 corresponding to item ID; UI elements 614 corresponding to data; UI elements 616 corresponding to QTY; UI elements 624 corresponding to anomaly score; and UI elements 628 corresponding to anomaly label. Specific values for those dimensions and measure are shown in the pane 610 simply for purposes of illustration. The disclosure is not limited to those values, which are dictated by the particular anomaly data 148 resulting from a particular anomaly analysis.

The first data that constitutes the anomaly table can be referred to as item data. Because the item data is presented during execution of the client application 116, the client device 110 can retain the item data in system memory. The system memory can be embodied in one or multiple volatile memory devices, such as random-access memory (RAM) device(s). The pane 610, however, can include a selectable UI element 634 that in response to being selected, causes the client device 110 to retain the item data in mass storage integrated within the client device 110 or functionally coupled thereto. The selectable visual element 634 is labeled “Download Item Data” simply for the sake of nomenclature. The pane 610 also has a selectable UI element 638 that, in response to being selected, causes the client device 110 to retain received anomaly data 148 in mass storage integrated within the client device 110 or functionally coupled thereto. The selectable visual element 634 is labeled “Download Analysis Data” simply for the sake of nomenclature.

The UI 600 also includes a pane 640 that permits controlling presentation of a time series associated with an anomalous record. To that point, the pane 640 includes a selectable UI element 648 that in response to being selected, causes the client device 110 to present a menu of selectable item IDs. That menu includes the item IDs shown by the UI elements 612. Further, the pane 640 also includes a selectable UI element 648 that, in response to being selected, causes the client device 110 to generate a UI including a graph 650 (FIG. 6B) of a time series of the QTY corresponding to the selected item ID. As is shown in the abscissa of the graph 650, the date records 614 are indexed in terms of weekends. The time series can span a time interval that includes the training interval 134 and the detection interval 132. As mentioned in connection with the UI 130, the graph 650 also can present the first decision boundary 136a and the second decision boundary 136b.

In some embodiments, the anomaly detection subsystem 150 can expose a group of APIs that can permit configuration of a desired anomaly detection analysis or execution of the desired detection analysis, or both. In those embodiments, the anomaly detection subsystem 150 can include an API server that provide the group of APIs. In one example, that server can be retained in the memory 270 (FIG. 2). In another example, that server can be hosted by an API gateway device integrated into the anomaly detection subsystem 150 or functionally coupled thereto. Additionally, the configuration functionality described herein in connection with the sequence of user interfaces 120 can be accomplished via function calls towards the anomaly detection subsystem 150. Further, execution of a configured anomaly detection analysis also can be accomplished via a function call pertaining to the group of APIs.

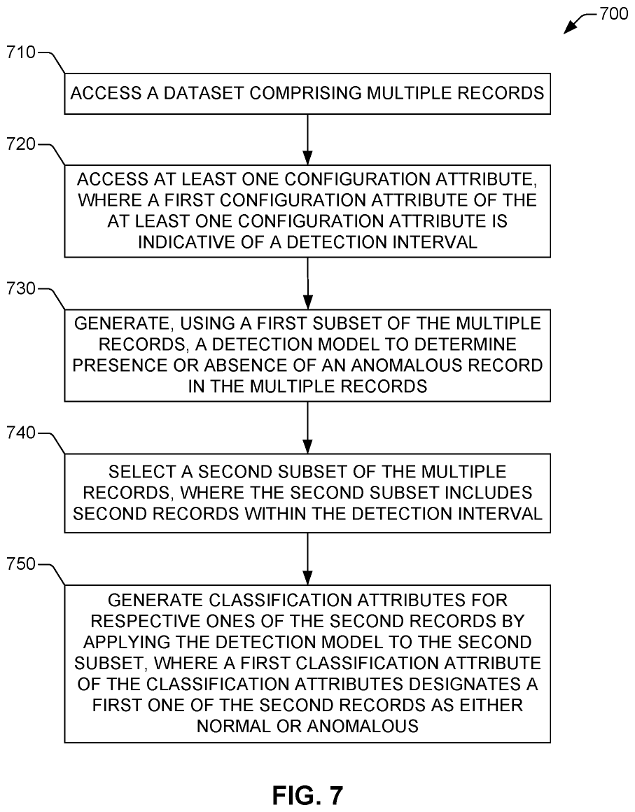

FIG. 7 illustrates an example of a method 700 for detecting anomalous records within a dataset, in accordance with one or more embodiments of this disclosure. A computing system can perform the example method 700 in its entirety or partially. To that end, the computing system includes computing resources that can implement at least one of the blocks included in the example method 700. The computing resources include, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. For instance, the computing system can include programming interface(s); an operating system; software for configuration and or control of a virtualized environment; firmware; and similar resources. The computing system can be embody, or can include, the anomaly detection subsystem 150 (FIG. 1), in some cases.

At block 710, the computing system can access a dataset comprising multiple records. The dataset can be accessed in several ways. In some cases, the computing system can receive a document containing the dataset. The document can be a comma-separated file, for example. In other cases, the computing system can receive a query from a client device (e.g., client device 110 (FIG. 1)) functionally coupled to the computing system. The query can be embodied in the query 144 (FIG. 1), for example. The computing system can resolve the query and, as a result, can receive the dataset comprising the multiple records.

At block 720, the computing system can access at least one configuration attribute. Such configuration attribute(s) can define one or more characteristics of an anomaly analysis. A first configuration attribute of the at least one configuration attribute defines a detection interval. As an example, the detection interval can be embodied in the detection interval 132 (FIG. 1).

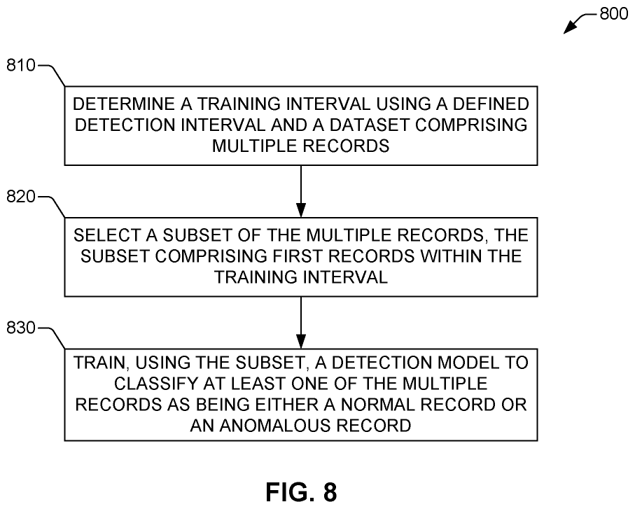

At block 730, the computing system can generate, using a subset of the multiple records, a detection model to determine presence or absence of an anomalous record within the multiple records. The detection model that is generated can classify each one of the multiple records within the dataset as either a normal record or an anomalous record. Thus, in some cases, the detection model that is generated can classify each one of the records within the detection interval. As mentioned, generating the detection model includes generating a first decision boundary and a second decision boundary by training the detection model using the subset of multiple records and one or multiple unsupervised training techniques. Each one of the first decision boundary and the second decision boundary separate a first domain where values of records are deemed normal and a second domain where values of records are deemed anomalous. Accordingly, the detection model classifies a measure record having a value within the first domain as a normal record. Further, the detection model classifies another measure record having a value outside that first domain as an anomalous record. The detection model can be generated by implementing the method illustrated in FIG. 8, in some embodiments.

At block 740, the computing system can select a second subset of the multiple records. The second subset that is selected includes second records within the detection interval.

At block 750, the computing system can generate classification attributes for respective ones of the second records by applying the detection model to the second subset. In some cases, a first classification attribute of the classification attributes designates a first one of the second records as one of a normal record or an anomalous record. In other cases, the first classification attribute designates the first one of the second records as one of a normal record, an anomalous record of a first type, or an anomalous record of a second type.

FIG. 8 illustrates an example of a method 800 for generating a detection model for anomalous records within a dataset, in accordance with one or more embodiments of this disclosure. A computing system can perform the example method 800 in its entirety or partially. To that end, the computing system includes computing resources that can implement at least one of the blocks included in the example method 800. The computing resources include, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. For instance, the computing system can include programming interface(s); an operating system; software for configuration and or control of a virtualized environment; firmware; and similar resources. In some embodiments, the computing system that implements the example method 800 can be the same computing system that implements the example method 700 (FIG. 7). The computing system can be embody, or can include, the anomaly detection subsystem 150 (FIG. 1), in some cases.

At block 810, the computing system can determine a training interval using the detection interval and the dataset. As an example, the training interval can be the training interval 134 depicted in FIG. 1. In some embodiments, rather than determining the training interval using the detection interval, the computing system can access one or more configuration attributes defining the training interval independently from the detection interval.

At block 820, the computing system can select a subset of the multiple records. The subset includes first records within the training interval.

At block 830, the computing system can train, using the subset, a detection model to classify at least one of the multiple records as being either a normal record or an anomalous records.

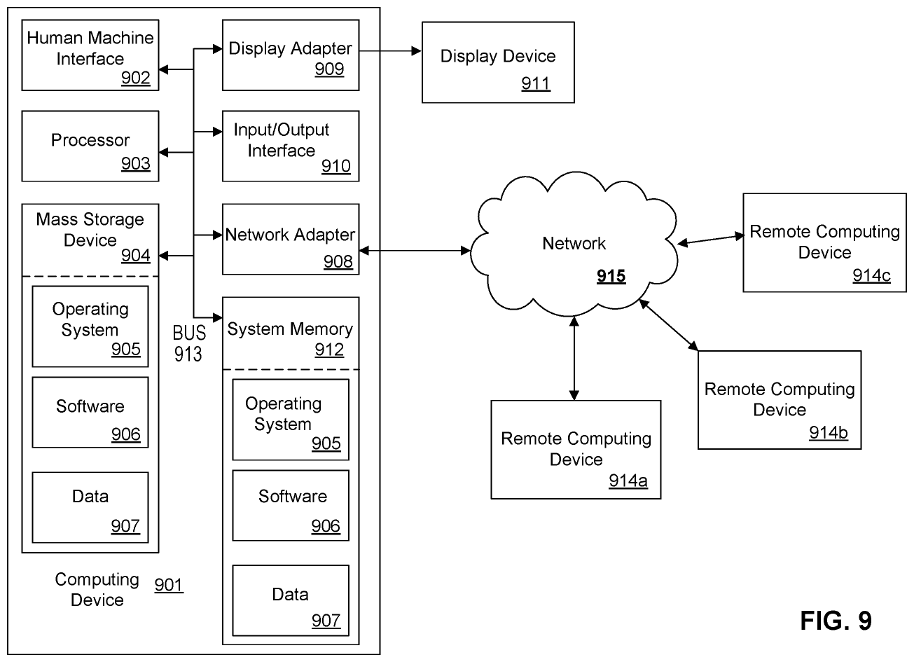

In order to provide some context, the computer-implemented method and systems of this disclosure can be implemented on the computing environment illustrated in FIG. 9 and described below. Similarly, the computer-implemented methods and systems disclosed herein can utilize one or more computing devices to perform one or more functions in one or more locations. FIG. 9 is a block diagram illustrating an example of a computing environment for performing the disclosed methods and/or implementing the disclosed systems. The operating environment shown in FIG. 9 is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment. The operating environment shown in FIG. 9 can embody at least a portion of the operating environment 100 (FIG. 1).

The computer-implemented methods and systems in accordance with this disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set-top boxes, programmable consumer electronics, network PCs, minicomputers, mainframe computers, distributed computing environments that comprise any of the above systems or devices, and the like.

The processing of the disclosed computer-implemented methods and systems can be performed by software components. The disclosed systems and computer-implemented methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and computer-implemented methods disclosed herein can be implemented via a general-purpose computing device in the form of a computing device 901. The components of the computing device 901 can comprise, but are not limited to, one or more processors 903, a system memory 912, and a system bus 913 that couples various system components including the one or more processors 903 to the system memory 912. The system can utilize parallel computing.

The system bus 913 represents one or more of several possible types of bus structures, including a memory bus or memory controller, a peripheral bus, an accelerated graphics port, or local bus using any of a variety of bus architectures. The bus 913, and all buses specified in this description can also be implemented over a wired or wireless network connection and each of the subsystems, including the one or more processors 903, a mass storage device 904, an operating system 905, software 906, data 907, a network adapter 908, the system memory 912, an Input/Output Interface 910, a display adapter 909, a display device 911, and a human-machine interface 902, can be contained within one or more remote computing devices 914a,b,c at physically separate locations, connected through buses of this form, in effect implementing a fully distributed system.

The computing device 901 typically comprises a variety of computer-readable media. Exemplary readable media can be any available media that is accessible by the computing device 901 and comprises, for example and not meant to be limiting, both volatile and non-volatile media, removable and non-removable media. The system memory 912 comprises computer readable media in the form of volatile memory, such as random access memory (RAM), and/or non-volatile memory, such as read only memory (ROM). The system memory 912 typically contains data such as the data 907 and/or program modules such as the operating system 905 and the software 906 that are immediately accessible to and/or are presently operated on by the one or more processors 903. The software 906 can include, in some embodiments, one or more of the modules described herein in connection with detection of anomalous records. As such, in at least some of those embodiments, the software 906 can include the ingestion module 210, the configuration module 220, the training module 230, the detection module 240, the scoring module 250, and the output 260. In other embodiments, the software 906 can include a different configuration of modules from that shown in FIG. 2, while still providing the functionality described herein in connection with the ingestion module 210, the configuration module 220, the training module 230, the detection module 240, the scoring module 250, and the output 260.

In some embodiments, program modules that constitute the software 906 can be retained (built or otherwise) in one or more remote computing devices functionally coupled to the computing device 901. Such remote computing device(s) can include, for example, remote computing device 914a, remote computing device 914b, and remote computing device 914c. Hence, as mentioned, functionality described herein in connection with detection of anomalous record can be provided in a distributed fashion, using parallel computing, for example.

In another aspect, the computing device 901 can also comprise other removable/non-removable, volatile/non-volatile computer storage media. By way of example, FIG. 9 illustrates the mass storage device 904 which can provide non-volatile storage of computer code, computer readable instructions, data structures, program modules, and other data for the computing device 901. For example and not meant to be limiting, the mass storage device 904 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 904, including by way of example, the operating system 905 and the software 906. Each of the operating system 905 and the software 906 (or some combination thereof) can comprise elements of the programming and the software 906. The data 907 can also be stored on the mass storage device 904. The data 907 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computing device 901 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the one or more processors 903 via the human-machine interface 902 that is coupled to the system bus 913, but can be connected by other interface and bus structures, such as a parallel port, game port, an IEEE 1394 Port (also known as a Firewire port), a serial port, or a universal serial bus (USB).

In yet another aspect, the display device 911 can also be connected to the system bus 913 via an interface, such as the display adapter 909. It is contemplated that the computing device 901 can have more than one display adapter 909 and the computing device 901 can have more than one display device 911. For example, the display device 911 can be a monitor, an LCD (Liquid Crystal Display), or a projector. In addition to the display device 911, other output peripheral devices can comprise components such as speakers (not shown) and a printer (not shown) which can be connected to the computing device 901 via the Input/Output Interface 910. Any operation and/or result of the methods can be output in any form to an output device. Such output can be any form of visual representation, including, but not limited to, textual, graphical, animation, audio, tactile, and the like. The display device 911 and computing device 901 can be part of one device, or separate devices.

The computing device 901 can operate in a networked environment using logical connections to one or more remote computing devices 914a,b,c. By way of example, a remote computing device can be a personal computer, portable computer, smartphone, a server, a router, a network computer, a peer device or other common network node, and so on. Logical connections between the computing device 901 and a remote computing device 914a,b,c can be made via a network 915, such as a local area network (LAN) and/or a general wide area network (WAN). Such network connections can be through the network adapter 908. The network adapter 908 can be implemented in both wired and wireless environments. In an aspect, one or more of the remote computing devices 914a,b,c can comprise an external engine and/or an interface to the external engine.

For purposes of illustration, application programs and other executable program components such as the operating system 905 are illustrated herein as discrete blocks, although it is recognized that such programs and components reside at various times in different storage components of the computing device 901, and are executed by the one or more processors 903 of the computer. An implementation of the software 906 can be stored on or transmitted across some form of computer-readable media. Any of the disclosed methods can be performed by computer readable instructions embodied on computer-readable media. Computer-readable media can be any available media that can be accessed by a computer. By way of example and not meant to be limiting, computer-readable media can comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

It is to be understood that the methods and systems described here are not limited to specific operations, processes, components, or structure described, or to the order or particular combination of such operations or components as described. It is also to be understood that the terminology used herein is for the purpose of describing exemplary embodiments only and is not intended to be restrictive or limiting.

As used herein the singular forms “a,” “an,” and “the” include both singular and plural referents unless the context clearly dictates otherwise. Values expressed as approximations, by use of antecedents such as “about” or “approximately,” shall include reasonable variations from the referenced values. If such approximate values are included with ranges, not only are the endpoints considered approximations, the magnitude of the range shall also be considered an approximation. Lists are to be considered exemplary and not restricted or limited to the elements comprising the list or to the order in which the elements have been listed unless the context clearly dictates otherwise.

Throughout the specification and claims of this disclosure, the following words have the meaning that is set forth: “comprise” and variations of the word, such as “comprising” and “comprises,” mean including but not limited to, and are not intended to exclude, for example, other additives, components, integers, or operations. “Include” and variations of the word, such as “including” are not intended to mean something that is restricted or limited to what is indicated as being included, or to exclude what is not indicated. “May” means something that is permissive but not restrictive or limiting. “Optional” or “optionally” means something that may or may not be included without changing the result or what is being described. “Prefer” and variations of the word such as “preferred” or “preferably” mean something that is exemplary and more ideal, but not required. “Such as” means something that serves simply as an example.

Operations and components described herein as being used to perform the disclosed methods and construct the disclosed systems are illustrative unless the context clearly dictates otherwise. It is to be understood that when combinations, subsets, interactions, groups, etc. of these operations and components are disclosed, that while specific reference of each various individual and collective combinations and permutation of these may not be explicitly disclosed, each is specifically contemplated and described herein, for all methods and systems. This applies to all aspects of this application including, but not limited to, operations in disclosed methods and/or the components disclosed in the systems. Thus, if there are a variety of additional operations that can be performed or components that can be added, it is understood that each of these additional operations can be performed and components added with any specific embodiment or combination of embodiments of the disclosed systems and methods.

Embodiments of this disclosure may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices, whether internal, networked, or cloud-based.

Embodiments of this disclosure have been described with reference to diagrams, flowcharts, and other illustrations of methods, systems, apparatuses, and computer program products. Each block of the block diagrams and flowchart illustrations, and combinations of blocks in the block diagrams and flowchart illustrations, respectively, can be implemented by processor-accessible instructions. Such instructions can include, for example, computer program instructions (e.g., processor-readable and/or processor-executable instructions). The processor-accessible instructions can be built (e.g., linked and compiled) and retained in processor-executable form in one or multiple memory devices or one or many other processor-accessible non-transitory storage media. These computer program instructions (built or otherwise) may be loaded onto a general-purpose computer, special purpose computer, or other programmable data processing apparatus to produce a machine. The loaded computer program instructions can be accessed and executed by one or multiple processors or other types of processing circuitry. In response to execution, the loaded computer program instructions provide the functionality described in connection with flowchart blocks (individually or in a particular combination) or blocks in block diagrams (individually or in a particular combination). Thus, such instructions which execute on the computer or other programmable data processing apparatus create a means for implementing the functions specified in the flowchart blocks (individually or in a particular combination) or blocks in block diagrams (individually or in a particular combination).

These computer program instructions may also be stored in a computer-readable memory that can direct a computer or other programmable data processing apparatus to function in a particular manner, such that the instructions stored in the computer-readable memory produce an article of manufacture including processor-accessible instruction (e.g., processor-readable instructions and/or processor-executable instructions) to implement the function specified in the flowchart blocks (individually or in a particular combination) or blocks in block diagrams (individually or in a particular combination). The computer program instructions (built or otherwise) may also be loaded onto a computer or other programmable data processing apparatus to cause a series of operations to be performed on the computer or other programmable apparatus to produce a computer-implemented process. The series of operations can be performed in response to execution by one or more processor or other types of processing circuitry. Thus, such instructions that execute on the computer or other programmable apparatus provide operations that implement the functions specified in the flowchart blocks (individually or in a particular combination) or blocks in block diagrams (individually or in a particular combination).

Accordingly, blocks of the block diagrams and flowchart illustrations support combinations of means for performing the specified functions in connection with such diagrams and/or flowchart illustrations, combinations of operations for performing the specified functions and program instruction means for performing the specified functions. Each block of the block diagrams and flowchart illustrations, and combinations of blocks in the block diagrams and flowchart illustrations, can be implemented by special-purpose hardware-based computer systems that perform the specified functions or operations, or combinations of special-purpose hardware and computer instructions.

The methods and systems can employ artificial intelligence techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the computer-implemented methods, apparatuses, devices, and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is in no way intended that an order be inferred, in any respect. This holds for any possible non-express basis for interpretation, including: matters of logic with respect to arrangement of operations or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A computing system, comprising:
at least one processor; and
at least one memory device having processor-executable instructions stored thereon that, in response to execution by the at least one processor, cause the computing system to:
access a dataset comprising multiple records;
access at least one configuration attribute, a first configuration attribute of the at least one configuration attribute is indicative of a detection interval;
generate, using a first subset of the multiple records, a detection model to determine presence or absence of an anomalous record within the multiple records;
select a second subset of the multiple records, the second subset comprising second records within the detection interval; and
generate classification attributes for respective ones of the second records by applying the detection model to the second subset, wherein a first classification attribute of the classification attributes designates a first one of the second records as one of normal or anomalous.

2. The computing system of claim 1, the at least one memory device having further processor-executable instructions stored thereon that in response to execution by the at least one processor further cause the computing system to cause a client device to present a graph representing a time series of a portion of the multiple records, the graph comprising one or more anomalous values of respective anomalous records.

3. The computing system of claim 1, wherein accessing the dataset comprises resolving a query directed to a defined database corresponding to a defined server device.

4. The computing system of claim 1, wherein accessing the at least one configuration attribute comprises receiving a second configuration attribute indicative of selection of the detection model from a group of defined detection models.

5. The computing system of claim 1, wherein the detection model comprises an isolation forest model, a time-series model, or a median absolute deviation model.

6. The computing system of claim 1, wherein generating, using the first subset of the multiple records, the detection model comprises,
determining a training interval using the at least one configuration attribute, the training interval comprising historical records relative to the second records;
selecting the first subset, wherein the first subset comprises the historical records; and
training, using the first subset and one or more unsupervised training techniques, the detection model to determine the presence or the absence of the anomalous record within the multiple records.

7. The computing system of claim 1, wherein generating, using the first subset of the multiple records, the detection model comprises generating a first decision boundary and a second decision boundary, wherein each one of the first decision boundary and the second decision boundary separates a first domain where values of records are deemed normal and a second domain where values of records are deemed anomalous.

8. A method comprising:
accessing, by a computing system comprising at least one processor, a dataset comprising multiple records;
accessing, by the computing system, at least one configuration attribute, a first configuration attribute of the at least one configuration attribute is indicative of a detection interval;
generating, by the computing system, using a first subset of the multiple records, a detection model to determine presence or absence of an anomalous record within the multiple records;
selecting, by the computing system, a second subset of the multiple records, the second subset comprising second records within the detection interval; and
generating, by the computing system, classification attributes for respective ones of the second records by applying the detection model to the second subset, wherein a first classification attribute of the classification attributes designates a first one of the second records as one of normal or anomalous.

9. The method of claim 8, further comprising causing a client device to present a graph representing a time series of a portion of the multiple records, the graph comprising one or more anomalous values of respective anomalous records.

10. The method of claim 8, wherein accessing the dataset comprises resolving a query directed to a defined database corresponding to a defined server device.

11. The method of claim 8, wherein accessing the at least one configuration attribute comprises receiving a second configuration attribute indicative of selection of the detection model from a group of defined detection models.

12. The method of claim 8, wherein the detection model comprises an isolation forest model, a time-series model, or a median absolute deviation model.

13. The method of claim 8, wherein the generating comprises,
determining a training interval using the at least one configuration attribute, the training interval comprising historical records relative to the second records;
selecting the first subset, wherein the first subset comprises the historical records; and
training, using the first subset and one or more unsupervised training techniques, the detection model to determine the presence or the absence of the anomalous record within the multiple records.

14. The method of claim 8, wherein the generating comprises generating a first decision boundary and a second decision boundary, wherein each one of the first decision boundary and the second decision boundary separates a first domain where values of records are deemed normal and a second domain where values of records are deemed anomalous.

15. At least one computer-readable non-transitory storage medium having processor-executable instructions stored thereon that, in response to execution, cause a computing system to:
access a dataset comprising multiple records;
access at least one configuration attribute, a first configuration attribute of the at least one configuration attribute is indicative of a detection interval;
generate, using a first subset of the multiple records, a detection model to determine presence or absence of an anomalous record within the multiple records;
select a second subset of the multiple records, the second subset comprising second records within the detection interval; and
generate classification attributes for respective ones of the second records by applying the detection model to the second subset, wherein a first classification attribute of the classification attributes designates a first one of the second records as one of normal or anomalous.

16. The at least one computer-readable non-transitory storage medium of claim 15, wherein the processor-executable instructions, in response to further execution, further cause the computing system to cause a client device to present a graph representing a time series of a portion of the multiple records, the graph comprising one or more anomalous values of respective anomalous records.

17. The at least one computer-readable non-transitory storage medium of claim 15, wherein accessing the dataset comprises resolving a query directed to a defined database corresponding to a defined server device.

18. The at least one computer-readable non-transitory storage medium of claim 15, wherein accessing the at least one configuration attribute comprises receiving a second configuration attribute indicative of selection of the detection model from a group of defined detection models.

19. The at least one computer-readable non-transitory storage medium of claim 15, wherein
generating, using the first subset of the multiple records, the detection model comprises,
determining a training interval using the at least one configuration attribute, the training interval comprising historical records relative to the second records;
selecting the first subset, wherein the first subset comprises the historical records; and
training, using the first subset and one or more unsupervised training techniques, the detection model to determine the presence or the absence of the anomalous record within the multiple records.

20. The at least one computer-readable non-transitory storage medium of claim 15, wherein generating, using the first subset of the multiple records, the detection model comprises generating a first decision boundary and a second decision boundary, wherein each one of the first decision boundary and the second decision boundary separates a first domain where values of records are deemed normal and a second domain where values of records are deemed anomalous.
